(19) United States
(12) Patent Application Publication
(10) Pub. No.: US 2019/0270094 A1
(43) Pub. Date: Sep. 5, 2019

(54) BOILER

(71) Applicant: TASSU ESP OY, Mikkeli (FI)

(72) Inventors: Ari LAITINEN, Tampere (FI); Mika RÄIHÄ, Mikkeli (FI); Seppo PAAVILAINEN, Mikkeli (FI); Jorma KESKINEN, Tampere (FI)

(73) Assignee: TASSU ESP OY, Mikkeli (FI)

(21) Appl. No.: 16/367,096

(22) Filed: Mar. 27, 2019

Related U.S. Application Data
(63) Continuation-in-part of application No. 14/426,714, filed on Mar. 6, 2015, now abandoned.

(30) Foreign Application Priority Data
Sep. 6, 2012 (FI) 20125919

(51) Int. Cl. B03C 3/12; F23J 15/02; B03C 3/06; B03C 3/38; B03C 3/41; B03C 3/49; B03C 3/74

(52) U.S. Cl. CPC B03C 3/12; F23J 15/022; B03C 3/06; B03C 3/38; B03C 2201/06; B03C 3/49; B03C 3/743; F23J 2217/102; B03C 3/41

(57) ABSTRACT

A boiler includes a flow channel having a selected chamber delimited by walls made at least partly of conductive material and being grounded, and a device arranged at least partially inside the selected chamber. The device includes an ion source comprising a corona electrode and an electrically passive body having an opening for corona discharge. The corona electrode is located inside the electrically passive body. A fan/shielding-gas connection is in the electrically passive body. The shielding gas exits the electrically passive body through the opening. The device also includes a high-voltage source for the corona electrode. The walls of the selected chamber of the boiler form a ground potential for the corona electrode to collect the fine particles of flue gases on the walls of the selected chamber.

### CROSS-REFERENCE TO RELATED APPLICATIONS

This application is a Continuation-in-Part of U.S. application Ser. No. 14/426,714 filed Mar. 6, 2015, which was a U.S. National Stage Application of International Application No. PCT/FI2013/050851 filed Sep. 4, 2013 and claiming priority to Finland Application No. 20125919, filed Sep. 6, 2012, the disclosures of all of which are incorporated herein by reference in their entireties.

### TECHNICAL FIELD

The present invention relates to a boiler.

### BACKGROUND OF THE INVENTION

Aerosol fine particles, i.e. particles floating in a gas, arise in many natural and man-made processes. Examples of natural processes are pollen particles arising from plants, sea aerosols caused by wind and evaporation, and dust lifted by the wind from the surface of the ground. The most common of man-made processes is the use of organic fuels, such as the use of fossil or bio-fuels in energy production. Many of these aerosol fine particles are detrimental to health. Particles arising in natural processes may cause allergic symptoms in people and detrimental organic compounds may also occur in some processes. Particles arising in combustion and industrial processes for their part often contain not only detrimental organic compounds, but also heavy metals. Small particles, less than a micrometre in size, may cause problems in health purely due to their small size, when they induce defence reactions in the body.

Several different methods are known for filtering aerosol particles from gases. The most efficient of these are various fibre filters and electrical filters. In fibre filters, separation is based on the inertia of aerosol particles impacting the material of the filter. In electrical filters, aerosol particles are charged electrically and their movement is influenced with the aid of an electric field, so that they collide with collector surfaces. The advantage of electrical filters is a small pressure drop and easier detachment of the collected solids from the collector surfaces for further treatment.

In traditional electric filters aerosol particles are charged typically with the aid of gas ions arising in a corona discharge. The charged aerosol particles are transferred with the aid of an external electrical field to a collector plate. The electrodes creating a corona discharge are generally located in the flue gas and can also form an electric field used to collect aerosol particles (a so-called one-stage electric filter). Known drawbacks of the method are keeping the electrodes and high-voltage insulators used in a corona discharge clean. The operation of traditional electric filters also limits the geometry of the equipment. Good filtering efficiency is achieved only with cylindrical or flat-plate structures.

Traditional electric filters can be combined with other functions, such as heat recovery. However, it is then necessary to operate within the boundary conditions set by filtering, and the thermal transfer process cannot be optimized.

Aerosol particles can also be collected without the effect of an external electric field. This phenomenon called chamber charging filtering is based on exploiting an electric field created by unipolar charged particles when guiding particles to the collector surfaces. A cloud formed by unipolar charged aerosol particles tends to expand due to the effect of internal electrical repulsive forces and in a delimited chamber some of the particles are driven onto the walls. However, the method is not particularly efficient and in it is theoretically possible to achieve a cleaning effect of only about 40% by using it. The electric field formed by of charged aerosol parts is not as powerful as a field formed by an external voltage source. In addition, the electric field formed by an aerosol particle cloud weakens as filtering progresses.

### SUMMARY OF THE INVENTION

The invention is intended to create a boiler comprising a flow channel for flue gases having a selected chamber delimited by walls made at least partly of conductive material, the selected chamber being grounded and a device arranged at least partially inside the selected chamber for forming a first electric field to collect the fine particles of flue gases on the walls of the selected chamber, the device comprising

an ion source for creating gas ions with aid of a corona discharge, the ion source comprising a corona electrode for creating the corona discharge, an electrically passive body having an opening for corona discharge, the corona electrode being located inside the electrically passive body and a fan/shielding-gas connection in the electrically passive body for feeding shielding gas inside the electrically passive body in contact with the corona electrode to prevent dirtying of the ion source, the shielding gas exiting the electrically passive body through the opening; and

a high-voltage source for the corona electrode;

in which boiler the walls of the selected chamber form a ground potential for the corona electrode to collect the fine particles of flue gases on the walls of the selected chamber.

In the boiler the number and life of the gas ions created by the corona electrode increases, so that the efficiency of the separation of fine particles can be increased.

According to an embodiment the electrically passive body has side walls and a rear wall, the corona electrode extending through the rear wall. This enables the use of a straight corona electrode.

The shielding gas connection may be formed in the rear wall. Thus the shielding gas is in connection with the corona electrode on the whole length of the exposed surface of the corona electrode keeping it clean.

The device is preferably situated in such chamber, in which the flow velocity of the flue gases past the corona electrode is 0.1-1.5 m/s, preferably 0.1-0.5 m/s. In this way the fine particles are able to be charged properly and collect on the walls of the chamber. At the same time, the flow velocity is sufficiently low for the risk of the fine particles collected detaching from the walls to be small.

The diameter of the body is 10-50%, preferably 15-40% of the diameter of the chamber. Thus the first electric field creating gas ions will be sufficiently strong over the entire area of the selected chamber.

According to one embodiment, the boiler includes a fan for feeding a shielding gas in connection with the feed-through between the body and the wall. With the aid of the feed of a shielding gas the chamber between the body and the wall is kept clean, so that a surface layer causing leak flows is not able to arise.

According to one embodiment, the device can be aligned relative to the chamber in the case of the corona electrode. In other words the corona electrode is perpendicular to the wall of the chamber. Thus the ions creates can be directed more effectively to achieve a better cleaning ability and at the same time also to increase the charge received by the particles to increase the collection efficiency.

In the solution according to the invention, the average strength of the first electric field used to collect the particles can be increased to be as large as the field created by an external voltage source in traditional electric filters.

Because the ions used both for charging the aerosol particles and for creating the collection field are created in a shielding airflow outside the actual gas being cleaned, the problem of the dirtying of the corona electrode and the insulation is avoided.

The ions required to charge the aerosol particles and to collect the particles can be produced either at the same time (one-stage filtering) or separately (two-stage filtering).

Preferably corona electrode is located at a distance from the walls acting as a collector surface the distance being calculated by diving the operating voltage of the corona electrode by the voltage of the corona electrode that is 50-95% of a breakdown voltage of 7 kV/cm. This enables the ions to have a sufficiently long lifetime to reach the collecting surfaces.

According to one embodiment, the charging and collection of the particles can be performed in any partly delimited chamber containing the gas to be cleaned. An example of such a chamber is the heat exchanger of a pellet burner, in which the necessary equipment for cleaning collected solids already exists. A second example is the part of a flue duct to be connected with the ash pan of a fireplace, into which the collected solids can be emptied in connection with the emptying of the ash pan. The filter can also be implemented in a partly delimited chamber designed particularly for the filter.

According to one embodiment, the shielding gas is used to keep both the ion source and the corona electrode clean. In this way leak flows and breakdowns on both the inner and outer surfaces of the body are avoided.

The boiler according to the invention is best suited for diesel and wood-burning processes and processes of the glass industry. The size of fine particles from wood burning is on average less than 0.3 micrometers and from the combustion of diesel slightly less than this and in glass-industry processes less than 0.7 micrometers. In the boiler the recovery of fine particles can be performed without a separate collector, using the walls of a closed chamber for collection.

The operating voltage of the corona electrode of the device is preferably 50-95%, preferably 80-90% of the breakdown voltage. In this way it is possible to ensure the formation of a corona discharge under all conditions.

The electrically passive body is preferably manufactured from a ceramic material, the volume resistivity of which is at least 4*106 ohm-cm, preferably at least 4*107 ohm-cm, most preferably 4*108 ohm-cm at a temperature of 500° C. Such a ceramic material retains its electrical insularity even at high temperatures, and does not cause leak flows.

The boiler may be used with a method for collecting fine particles from flue gases on selected collector surfaces, in which the flue gases containing fine particles exiting the combustion chamber are led to a selected chamber delimited by walls, which is part of the flue gas flow channel. With the aid of a corona discharge of a corona electrode which is in high-voltage relative to the collector surfaces of the ion source, gas ions are formed in a separate body relative to the chamber. Gas ions formed are led to a selected chamber in order to charge the fine particles contained in the flue gas with the aid of gas ions. The charged fine particles are collected on the collector surfaces. The fine particles can be collected without a separate collection area, as the walls of the selected chamber act as such as the collection area.

Preferably a second electric field is formed with the aid of gas ions, which is at least over a specific length of the selected flow channel more powerful than a third electric field formed by the corona electrode against the ground potential. In other words the electrically charged aerosol particles are collected by exploiting the second electric field formed by the gas ions. In this way, the collection efficiency of the fine particles can be raised to as much as more than 90% of the total amount of fine particles contained in the flue gases.

The corona discharge can be created with the aid of a corona electrode and a surface in the ground potential relative to the corona electrode.

Preferably the electrical field created with the aid of the gas ions is stronger than the electric field formed by the corona electrode against the ground potential of the selected flow channel over a length of 3-30 cm, preferably 10-25 cm.

Preferably fine particles of a size of less than 10 μm, preferably less than 2 μm are collected. It is extremely difficult to collect these fine particles with the aid of conventional fibre filters.

The life of gas ions formed with the aid of a corona discharge can be 30-150 ms, preferably 50-80 ms. Thus they are able to charge a considerable number of fine particles.

The operating voltage of the corona electrode of the ion source is preferably 50-95%, preferably 80-90% of the breakdown voltage. The voltage is tried to be maximized without breakdowns that weaken filtering.

The gas ions can be mixed with flue gases, the temperature of which is less than 700° C., preferably less than 500° C. At these temperatures, the collection of fine particles takes place efficiently.

According to one embodiment the gas ions are mixed with the flue gases at a point that is out of reach of the combustion flame. The ions arising in connection with combustion will then not disturb the charging of the fine particles.

The excess pressure used can be 50-2000 Pa, preferably 100-500 Pa relative to the chamber. Thus a sufficient shielding-gas flow is created, so that the entry of flue gases to the ion-source body can be prevented.

According to one embodiment, the fine particles are collected inside the combustion boiler. The collection of the fine particles can then be implemented, for example, in the chimney without a separate process stage.

Preferably the operating voltage is proportional to the distance between the corona electrode and the walls of the selected chamber.

The device can be located in such chamber, in which the flow velocity of the flue gases in the area of influence of the corona electrode is 0.1-1.5 m/s, preferably 0.1-0.5 m/s. Thus the fine particles contained in the flue gases can be charged properly and collect efficiently on the walls of the boiler. In this connection, the term area of influence refers to an area around the corona electrode which is a maximum of 30 cm long.

The diameter of the body of the ion source can 20-50%, preferably 15-40% of the diameter of the chamber. The electric field formed by the gas ions will then be formed sufficiently effectively over the whole area of the selected chamber.

An electrically passive body is preferably formed from ceramic material, which retains its insulating capacity at the operating temperature. Thus the formation of leak flows is effectively prevented.

The electrically passive body may comprise a gas guide for accelerating the flow of the shielding gas exiting the electrically passive body and obstructing entry of flue gases inside the electrically passive body. The use of gas guide facilitates the generation of sufficient excess pressure inside the electrically passive body.

Preferably the gas guide includes a narrowing part and a diffusor part. This facilitates the functions of the gas guide.

The narrowing part and the diffusor part may be at an angle of 30-40° to longitudinal direction of the electrically passive body.

According to an embodiment the electrically passive body comprising a gas guide for accelerating the flow of the shielding gas exiting the electrically passive body and obstructing entry of flue gases inside the electrically passive body and the boiler comprising a second fan for feeding a shielding gas inside the electrically passive body through the fan/shielding gas connection wherein the gas guide and the second fan are designed to create an excess pressure of 50-2000 Pa, preferably 100-500 Pa inside the electrically passive body relative to the selected chamber.

According to an embodiment the electrically passive body comprising a gas guide for accelerating the flow of the shielding gas exiting the electrically passive body and obstructing entry of flue gases inside the electrically passive body and the boiler comprising a second fan for feeding a shielding gas inside the electrically passive through the fan/shielding gas connection wherein the gas guide and the second fan are designed to create an excess pressure of 50-2000 Pa inside the electrically passive body relative to the selected chamber and the ion source is arranged to create gas ions having a life of 30-150 ms, preferably 50-80 ms with aid of the corona electrode.

Preferably the electrically passive body is fed through a feed-through of the walls of the chamber, the electrical passive body being arranged at least partially inside the selected chamber.

### BRIEF DESCRIPTION OF THE DRAWINGS

In the following, the invention is described in detail with reference to the accompanying drawings depicting some applications of the invention, in which

FIG. 1 shows a gas-cleaning apparatus, which contains an ion source for charging particles and creating a filtering field, as well as a surface for collecting particles,

FIG. 2 shows a gas-cleaning apparatus, which contains an ion source for charging particles, an ion source for creating a filtering field, and a surface for collecting particles,

FIG. 3a shows a schematic diagram of one embodiment of the ion source,

FIG. 3b shows a schematic diagram of a second embodiment of the ion source,

FIG. 4 shows an example of the field strength of the electrical field of a traditional electrical filter,

FIG. 5 shows an example of the electric field created by one embodiment of the ion source,

FIG. 6 shows an example of the field strength of the electrical field created by ions according to the invention,

FIG. 7 shows one embodiment of the invention,

FIG. 8 shows one embodiment of the invention, and

FIG. 9 shows the use of a shielding gas for keeping body of the ion source clean.

### DETAILED DESCRIPTION OF THE INVENTION

For reasons of clarity, the figures only show the details necessary in terms of the invention. Structures and details that are unnecessary in terms of the invention, but which will be obvious to one skilled in the art, have been omitted from the figures, in order to emphasize the specific features of the invention. Such unnecessary details are, among others, the firebox and the more detailed structures of the heat exchanger.

The boiler according to the invention may be utilized using a method wherein a flue gas containing fine particles, which can come from, for example, a boiler, is cleaned of fine particles by collecting the fine particles on collector surfaces. The flue gases containing fine particles exiting the combustion chamber are led to a selected chamber acting as a flow channel delimited by walls, such as, for example, a flow channel flowing downwards from the boiler. An ion source separate form the selected chamber delimited by walls is situated in the flow channel and contains a high-voltage corona electrode and an electrically passive body, in which the corona electrode is located. The ion source can also include a fan, by means of which a shielding gas is blown around the corona electrode to prevent dirtying. The high voltage of the corona electrode discharges as a corona discharge between the corona electrode and the walls of the delimited chamber in a ground potential relative to the corona electrode, which forms together with the shielding gas charged gas ions. In other words, in the method according to the invention, the body of the ion source is electrically passive.

When the gas ions are led out of the body of the ion source, they mix with the flue gases and at the same time the gas ions charge the fine particles contained in the flue gases. The gas ions form an ion cloud, which creates through a chamber charging phenomenon in the chamber delimited by walls an electric field E, which drives the charged fine particles VH to the collector surfaces formed by the collector area KA of the selected chamber, i.e. to the walls of the selected chamber. A second electric field formed by the gas ions is preferably over a specific distance of the flow channel formed by the selected chamber stronger than a first electric field formed by the corona electrode against the ground potential. Preferably this distance is 3-30 cm, most preferably 10-25 cm, so that the life of the gas ions is up to tens that of solutions according to the prior art. The counter-potential of the corona electrode and the collector surface of the charged fine particles is formed of the walls of the selected chamber.

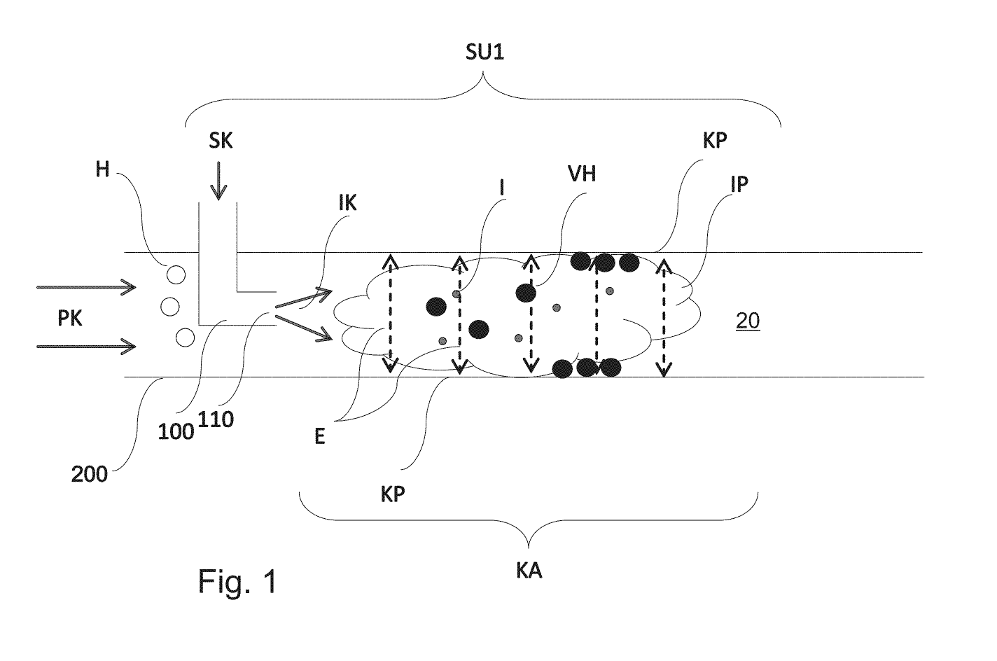

FIG. 1 shows one embodiment of the selected chamber 20 of the boiler. The chamber 20 is delimited by walls 200. The flue gas PK to be cleaned and containing fine particles flows in the chamber 20. An ion source 100 is placed in the selected chamber 20 for feeding ionized gas IK, i.e. gas ions. The ionized gas IK fed by the ion source 100 to the chamber 20 can be mixed with the flue gas PK to be cleaned through the turbulence effect caused by the body 110 of the ion source 100. Because the unipolar gas ions of the ionized gas IK reject each other, the gas ions I can be mixed with the flue gas PK to be cleaned, with the aid of electrostatic forces. The gas ions I contained in the ionized gas IK charge the fine particles H in the gas. The fine particles H can be, for example, solid or liquid particles. The gas ions I form together with the charged fine particles VH an ion cloud IP. The ion cloud forms, through the chamber-charging phenomenon an electric field E, which drives the charged fine particles VH to the collector surfaces KP formed in the collector area KA of the selected chamber 20.

The shielding gas SK prevents dirty flue gas from entering the body 110 of the ion source 100. The properties of the shielding gas, such as composition and temperature, can be adjusted to optimize the operation of the filter. The output of the filtering can be improves by using several single-phase filter units SU1.

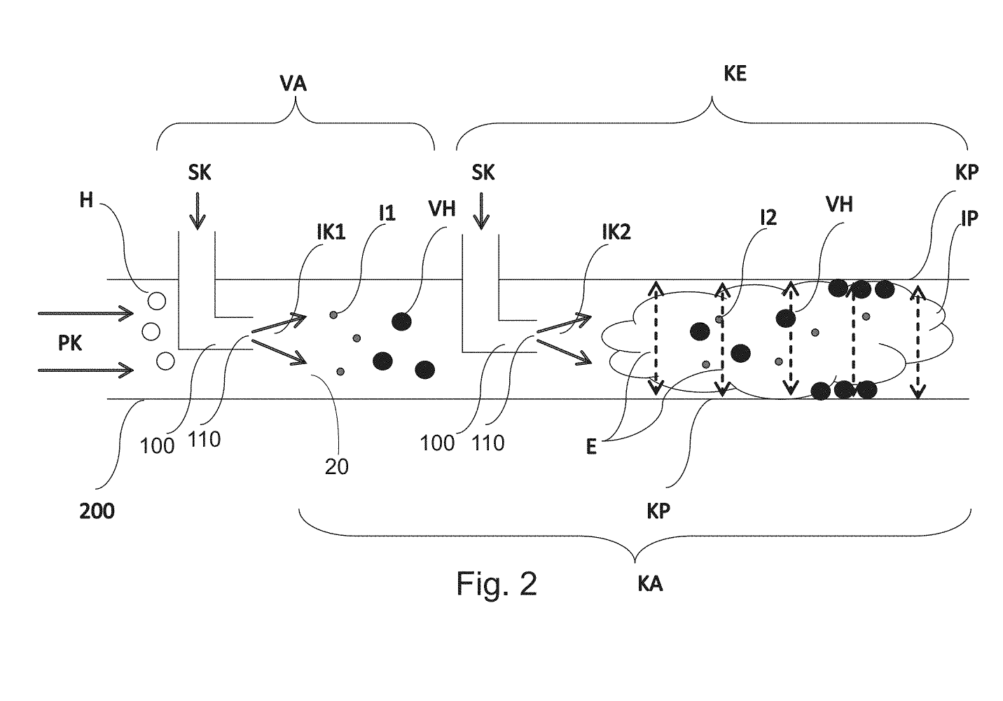

FIG. 2 shows another embodiment of the boiler which contains two ion sources 100. The boiler in question contains a selected chamber 20 delimited by walls, in which the flue gas PK to be cleaned flows, and two ion sources 100 for feeding ionized gas IK1 and IK2 to the selected chamber.

The ionized gas IK1 and IK2 fed by the ion sources 100 to the chamber 20 can be mixed with the flue gas PK through the turbulence effect caused by the channels 110. Because the unipolar gas ions of the ionized gases IK1 and IK2 reject each other, the gas ions I1 and I2 can be mixed with the flue gas to be cleaned with the aid of electrostatic forces. The gas ions I1 contained in the ionized gas IK1 produced by the ion source 100 charge the fine particles H in the gas, which collect on the collector surfaces according to FIG. 1. The fine particles H can be, for example, solid or liquid fine particles. The gas ions I2 of the ionized gas IK2 produced by the second ion source 100 form, together with the charged fine particles VH, an ion cloud IP. The ion cloud forms, through the chamber-charging phenomenon, a first electric field E, which drives the charged fine particles VH to the collector surfaces KP formed in the collection area KA of the chamber. Though in FIG. 2 the collection area is shown as forming only after the second ion source, it should, however, be understood that also after the first ion source forms its own electric field and collection area, correspondingly to FIG. 1.

The shielding gas SK prevents dirty gas from entering the ion sources 100. The properties of the shielding gas, such as composition and temperature, can be adjusted to optimize the operation of the filter. The effectiveness of the filtering can be improved by using several chargers VA and collectors KE in different combinations.

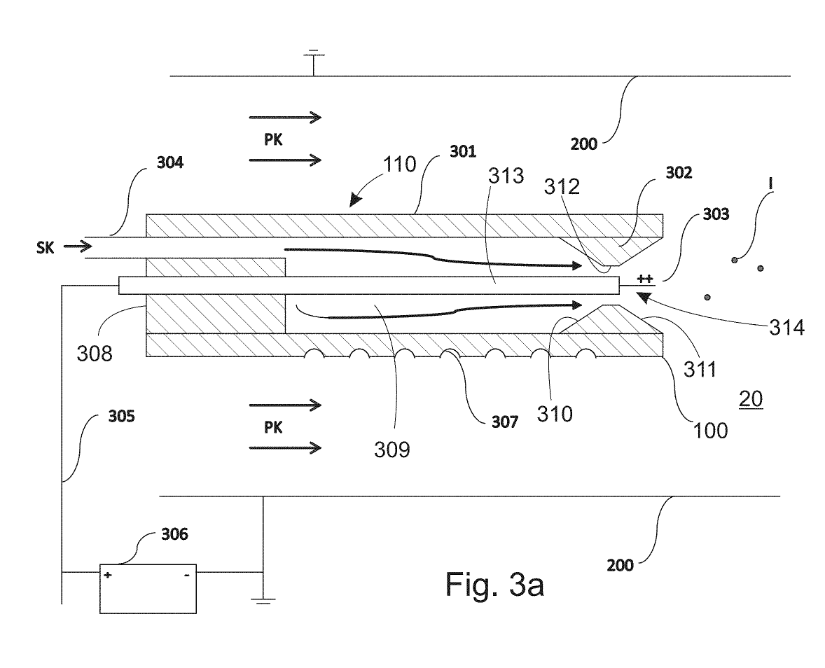

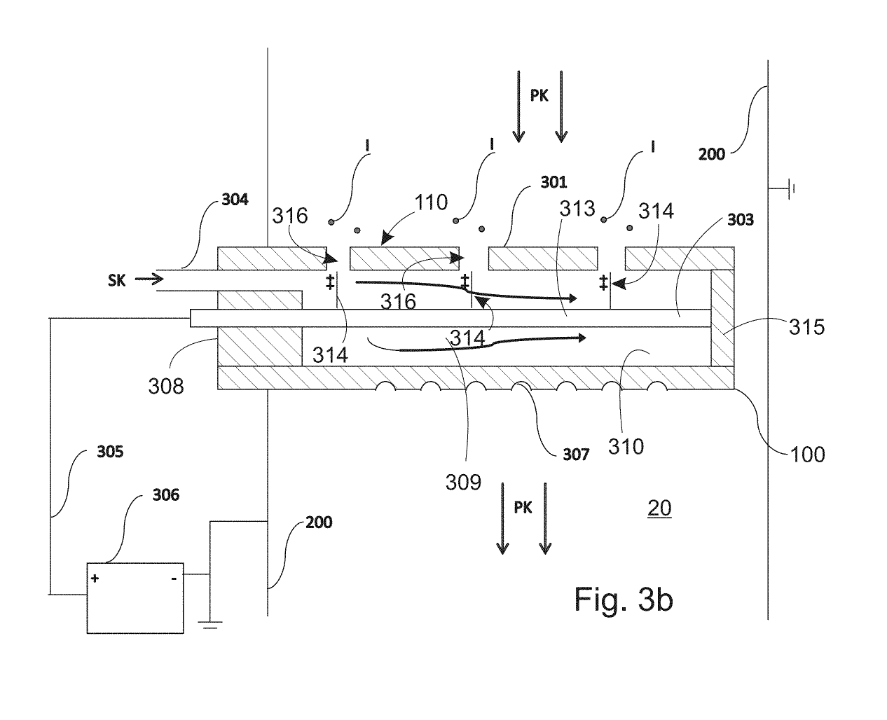

FIG. 3a shows a schematic diagram of one preferred embodiment of the ion source. In the figure, the distance between the body 110 and the walls 200 is not shown in the correct scale. The ion source 100 can comprise a body 301 forming the body 110, which is made from an electrically non-conducting material, a gas guide 302, a corona electrode 303, a shielding gas connection 304 for the shielding gas SK, a high-voltage conductor 305, as a high-voltage supply 306. The ion source 100 is located in a chamber 20 containing the flue gas PK to be cleaned, such as inside the flow channel. The gas ions arise in a corona discharge, which is formed between the corona electrode 303 and the walls 200 of the chamber 20. The walls 200 of the chamber 20 should be of a reasonably electrically conductive material and grounded. The terms a reasonably electrically conductive material refers to a material, the electrical conductivity of which is sufficient to prevent a significant amount of charge accumulating on the inner surfaces of the wall 200 of the chamber 20.

In this connection, the term electrically passive refers to the fact that the body of the ion source should have a sufficient electrical isolation capacity for the corona discharge to take place between the corona electrode 303 and the wall 200 of the chamber 20, and that electrons cannot travel in the body. More specifically, resistivity can be used as a gauge of separation ability, which should be at least 4*106 ohm-cm, preferably at least 4*107 ohm-cm, most preferably 4*108 at a temperature of 500° C., measured according to the ASTM-D1829 standard. This is possible in among other ways by selecting a substance with a sufficiently good insulation ability as the material for the body 301 of the ion source 100. A sufficient insulation ability can be achieved, for example, by many ceramic materials, such as aluminium oxide which is as pure as possible and which has the resistivity referred to above, or some other corresponding ceramic material. Sufficient electrical passivity can also be achieved by coating the body with an electrically passive substance and keeping the part inside the coating sufficiently cool, so that leak flows do not occur. As an alternative, it is also possible to use a catalytic coating in order to maintain insulation ability, for example, according to the principles known from diesel vehicles.

The electric insulation ability of the body 301 of the ion source 100 can be improved by shaping the outer surface of the body 301 in such a way that the distance of a surface discharge increases. In FIG. 3a, the electrically passive part is shown by hatching. In the cross-sectional view, in the lower part of the body 301 is an example of such surface patterning 307. The body 301 of the ion source can also be manufactured using a combination of several materials. The body 301 can be partly manufactured from an insulation, such as ceramics, and partly, for example, from metal. With the aid of an ion-source gas guide 302, it is possible to increase the velocity of the shielding-gas flow SK and thus boost its effect in maintaining cleanliness.

With the aid of an electrically passive body of the ion source all the gas ions formed with the aid of the corona discharge are brought from the ion source to the chamber delimited by the surrounding walls. The electrically passive ion-source body does not act as a ground destroying the gas ions unlike in solutions according to the prior art, in which only about a tenth of the gas ions formed exit the ion-source body to the selected chamber. With an electrically passive ion-source body, a greater gas ion density is achieved at least over part of the distance to the selected chamber, when the first electric field formed by the gas ions is stronger than a second electric field formed by the corona electrode. The first electric field driving gas ions to the walls is, on average, less than in solutions according to the prior art. For this reason, the life of the gas ions is many times that in solutions according to the prior art. Based on this, the boiler is possible to achieve a cleaning effect of more than 90%, in relation to fine particles.

With the aid of the gas guide 302, it is possible also to influence the flow of the shielding gas SK after the ion source 100, to promote mixing. The shielding gas SK is led to the ion source 100 through the shielding-gas connection 304. The shielding gas SK can be a gas substantially free of particles, which means that the particle content is so small that the particles collected inside the ion source do not cause significant dirtying of the internal parts of the ion source 100. The shielding gas SK can be, for example, air, water vapour, carbon dioxide, nitrogen, or a mixture of several gases. The pressure, flow quantity, and temperature of the shielding gas can adjusted to optimize the operation of the filter.

In the solution according to the invention, the pressure of the shielding gas can be kept considerably lower than that of solutions according to the prior art, because its task is to prevent dirtying of the ion source. However, the pressure of the shielding gas should be high enough to prevent the entry of the flue gases to the body of the ion source.

The corona discharge is created by raising the potential of the corona electrode 303 above the threshold voltage of the corona discharge, with the aid of a high-voltage source 306. The high-voltage source is connected to the corona electrode through a high-voltage conductor 305. The other terminal of the high-voltage source is grounded. The number of ions I created can be adjusted by adjusting the potential of the corona electrode. The value of the high voltage used by the ion source is proportional to the dimensions of the chamber of the application. In order for a corona discharge to take place in the corona electrode, a high voltage is required, which is at a maximum in the order of 7 kV/cm. Thus, the available voltage is determined according to the dimensions of the chamber used 10-200 kV, preferably 10-100 kV, the dimensions of the chamber being less than half a metre. This means that a single ion source can be used at a maximum in a radius of half a metre. In larger chambers, the chamber can divided into several smaller flow channels, in each of which its own ion source is used, so that the method can be used even in large chambers.

According to FIG. 3a, the body 110 of the ion source 100 is entirely insulated, so that it will not act as a ground for charged gas ions. The body 110 can be formed of a tubular component, in the middle of which the corona electrode 303 is situated. The cross-section of the body can also be a square or a corresponding shape. Preferably there is a rear wall 308 in the body 110, through which the corona electrode 303 is led. Between the rear wall 308 and the body 110 there is a shielding-gas connection 304, i.e. a connection through which shielding gas is blown into the body 110. The shielding gas is then in contact with the corona electrode 303. The shielding-gas flow can be produced, for example, with the aid of a low-power fan, which creates inside the body an excess pressure relative to the selected chamber surrounding the ion source. The fan can be part of the ion source or else the boiler fan or a separate fan can be used. Instead of a fan, it is also possible to use a pump or compressor to produce the shielding-gas flow. The shielding-gas flow can also be produced by exploiting the natural vacuum in the flue gas, in which case the shielding-gas flow is formed from the effect of the body's vacuum, without a separate pump or fan. After the rear wall 308, in the body 110 there is a larger chamber 309, which ends in the gas guide 302 at the end of the body 110.

The intention of the gas guide 302 is to accelerate the flow of the shielding gas in the final part of the body 110 and at the same time to be an obstacle to the entry of flue gases to the body 110. Gas guides can be, for example, pieces, which include a narrowing part 310 and a diffusor part 311. Both parts can be, for example, at an angle of 30-40° to the longitudinal direction of the body 110. Preferably there is a neck 312 between the narrowing part 310 and the diffusion part 311. The body part 313 of the corona electrode 303 preferably ends at the junction of the diffusion part 311 and the neck 312, and a separate corona needle 314, at the end of which the corona discharge takes place, is attached to the body part. In other words, the corona needle 314 is in the length of the diffusion part 311.

The technology of the ion source used in the device according to the invention to charge the aerosol particles of the flue gas is partly disclosed in patent FI 119468.

FIG. 3b shows another form of implementation of the ion source 100. This form of implementation differs from the form in FIG. 3a in that in this solution the body 110 is closed at the end with the aid of a front wall 315 and the side of the body 110 includes openings 316. One corona needle 314 can be located in each opening.

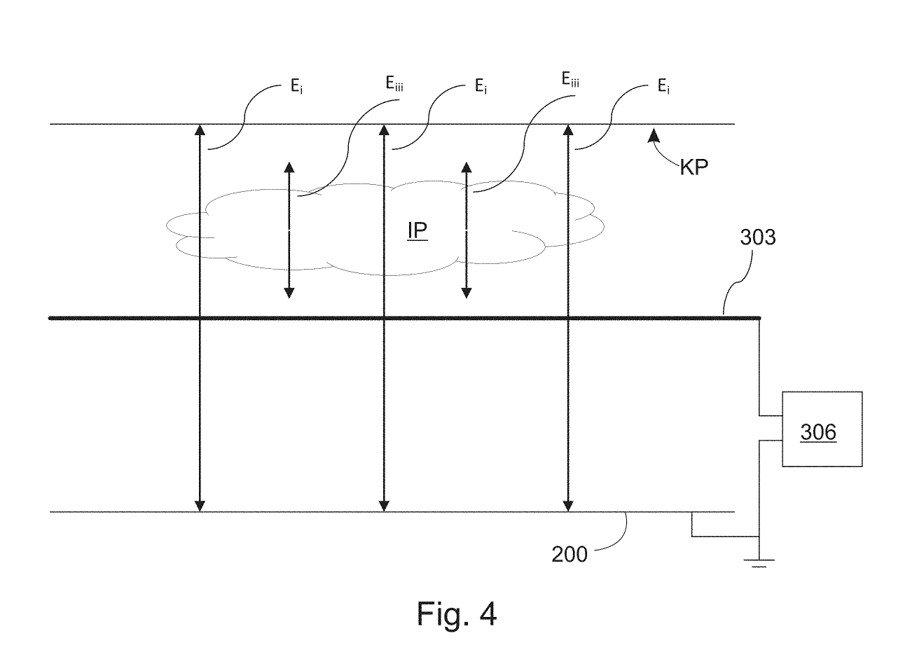

FIG. 4 shows an example of the components Ei and Eiii of the electric field formed towards the collector surface KP in an electric filter according to the prior art. The second electric field Ei is formed between the corona electrode and the collector surface KP acting as the counter electrode. As can be seen from FIG. 4, the fields Ei and Eiii are opposite to each other in the vicinity of the corona electrode, which weakens the value of the electric field E towards the collector surface pointing towards the particles in this area, and thus weakens the filtering of the particles. A third electric field Eii pointing towards the collector surface KP and formed of charged particles behaves in both in electrical filters of the prior art and in an electrical filter implemented according to the present invention in a corresponding manner to the first electric field Eiii formed by ions, and for this reason is not presented separately.

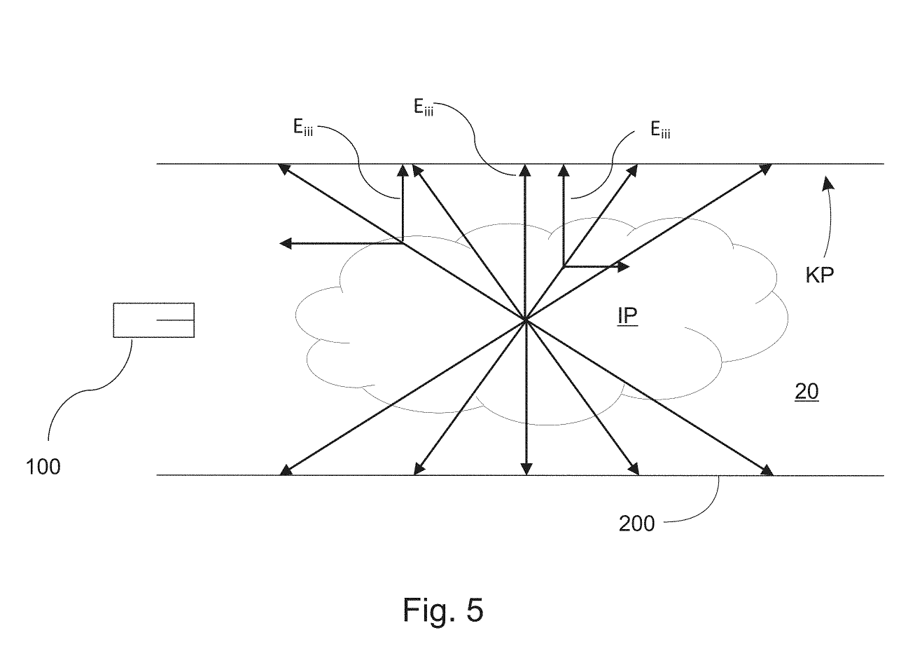

FIG. 5 shows a schematic diagram of the magnitude at different points in the collection area of the component Eiii towards the collector surface KP of the electric field caused by an ion cloud. It is typical of the solution according to the present invention that over at least a specific length of the collection area the first electric field Eiii is on average significantly stronger that the second electric field Ei. The term on average stronger refers in this connection to the fact that the first electric field Eiii is stronger than the second electric field Ei over most of a specific length of the flow channel, but that over this distance there may be specific local areas, in which the strength is the opposite. Such areas may be, for example, the edges of the flow channel.

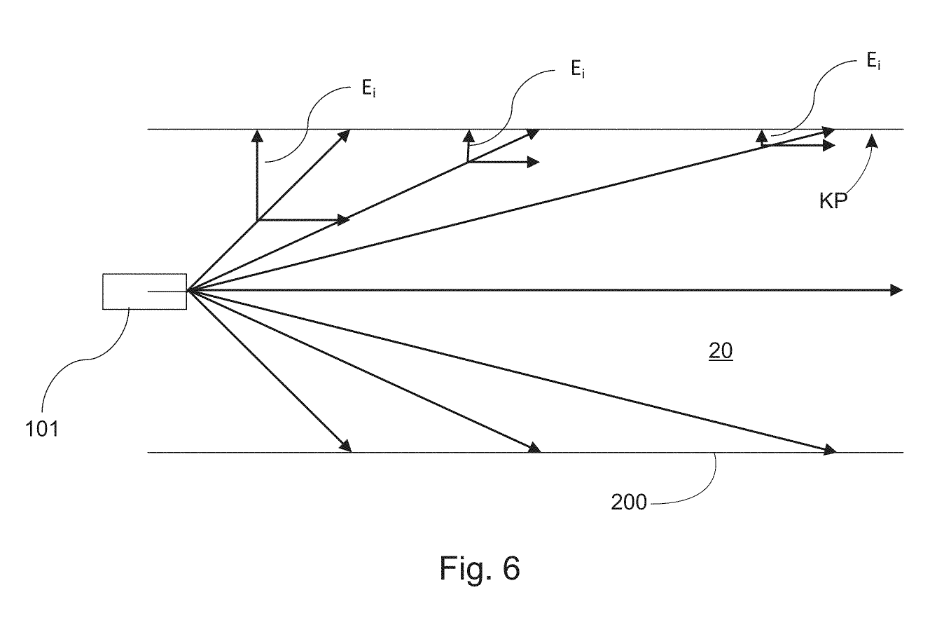

FIG. 6 shows a schematic diagram of the magnitude of the component Ei towards the collector surface of the electric field caused by the corona electrode of the ion source, at different points in the collection area. The effectiveness of the collection of the charged fine particles on the collection surfaces is affected by the charge received by the fine particles, the strength of the component towards the collection surface of the electric field affecting the fine particles, and the dwell time of the fine particles in the collection area. The component E towards the collection surface of the electric field affecting the particles consists of the second electric field Ei created by the corona electrode of the ion source, the third electric field Eii created by the charged particles, and the first electric field Eiii created by the ions according to the present invention, forming the equation

E=Ei+Eii+Eiii

In the solution according to the invention, the first and third electric fields Eiii and Eii are stronger in the collection area than Ei. The second electric field Ei can be regarded as the collection voltage used in an electrical filter of the prior art. The third electric field Eii is related to the electric field caused by the collection of particles in a chamber-charging filter of the prior art. The first electric field Eiii caused by the ions is the field boosting the collection specific to the present invention. The first electric field Eiii also appears in electric filters of the prior art, but in these solutions it is detrimental in terms of the filtering.

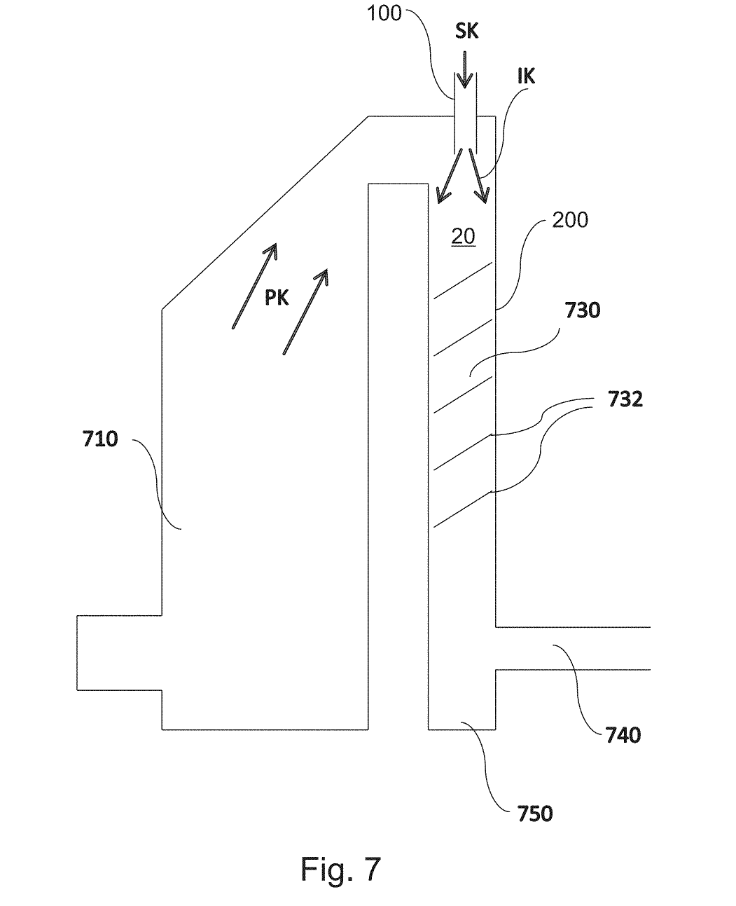

FIG. 7 shows a boiler according to an embodiment. The boiler in question contains at least a firebox 710, a heat exchanger 730 connected to it, a connection to the flue 740, and an ion source 100 for feeding ionized gas IK to the flue-gas flow PK to be cleaned. In addition, in connection with the heat exchanger 730 there is an operating element 732 suitable for cleaning the surface of the heat exchanger, and an ash pan 750. The ion source should be located outside of the reach of the flames of the firebox, as ions formed immediately during combustion disturb the cleaning of fine particles. In addition, it is preferable in terms of cleaning that the temperature is less than 700° C., most preferably less than 500° C. The ions of the ionized gas IK fed by the ion source 100 charge the fine particles of the flue gas PK to be cleaned. The gas ions of the ionized gas IK fed by the ion source 100 form an electric field, i.e. a charging field, in the area of the heat exchanger 730, due to the effect of which the charged flue-gas particles collect of the walls 200 of the heat exchanger 730.

The particles collected on the walls 734 of the heat exchanger 730 can be detached with the aid of the cleaning element 732, when they fall into a collection tray 750. The shielding gas SK prevents the dirty gas from entering the ion source 100. The properties of the shielding gas, such as composition and temperature, can be adjusted to optimize the operation of the filter. The cleaning element 732 can be, for example, some kind of sweeping element, for example, a continuously operating or periodically operating spiral or a so-called flutterer. Cleaning can be performed also during operation.

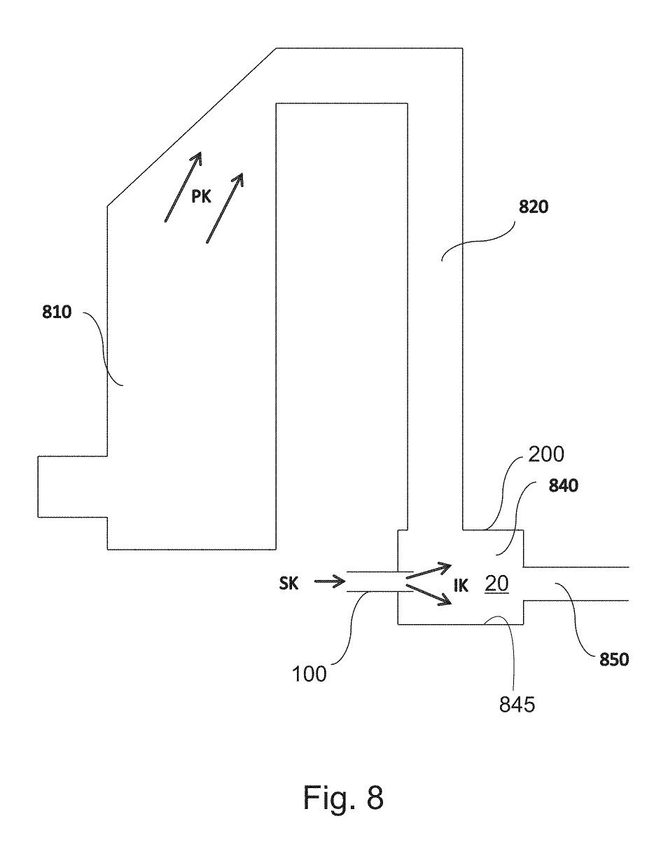

FIG. 8 shows a boiler according a second embodiment. The boiler in question contains at least a firebox 810, a flue 820 connected to it, a connection to the flue 850, an ash pan 840, and an ion source 100 for feeding ionized gas IK to the flue-gas flow PK to be cleaned. The ions of the ionized gas IK fed by the ion source 100 charge the fine particles of the flue gas PK to be cleaned. The gas ions of the ionized gas IK fed by the ion source 100 form an electric field inside the ash pan 840, i.e. the selected chamber, as a result of which the charged flue-gas particles collect on the walls 845 of the ash pan 840. The ash pan 840 can be cleaned, for example, by detaching it and shaking the ash collected in it into a suitable container. Shielding gas SK prevents dirty gas entering the ion source 830. The properties of the shielding gas, such as composition and temperature, can be adjusted to optimize the operation of the filter. The body of the ion source is preferably aligned so that the charged particles collect on the walls of the chamber on the entry-flow side. Thus fine particles that may detach during cleaning will not escape past the ion source.

In the boiler flue-gas fine particles can be cleaned directly in the boiler. The invention can be applied to 0.01-5.0 MW boilers, preferably 20-100 kW boilers.

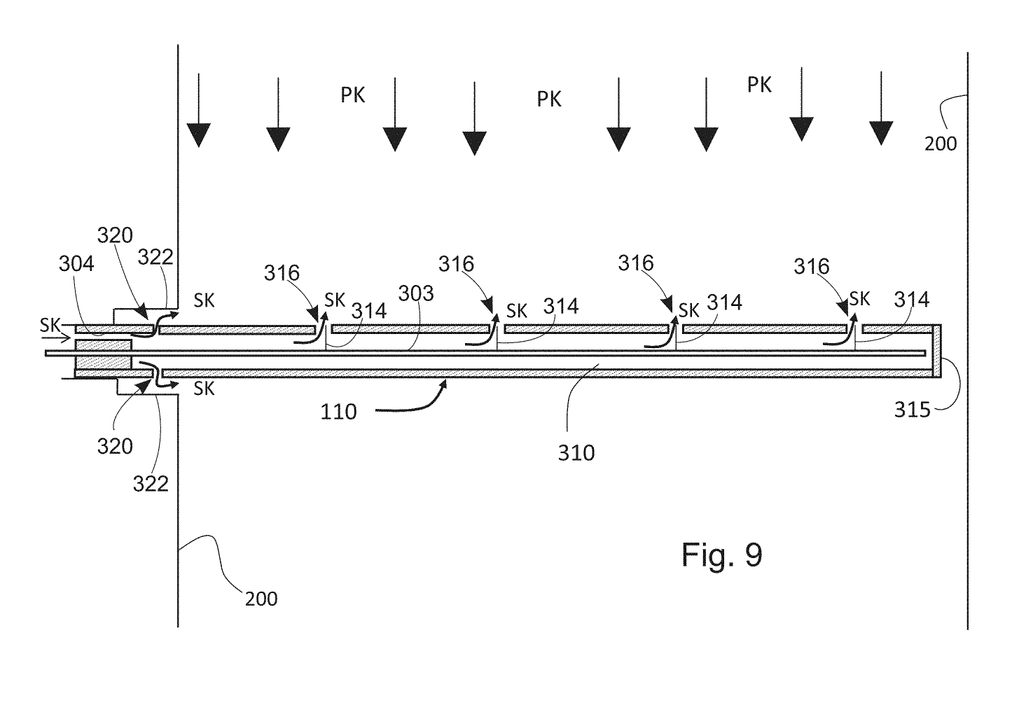

According to one embodiment, the boiler shown in FIG. 9 comprises a shielding-gas sources for keeping the corona electrode 303 and the feed-through 322 of the body 110 of the ion source clean. The feed-through 322 in this connection refers to an area of the outer surface, in which, with the aid of a shielding gas, dirtying and the formation of an electrically conductive layer of dirt is prevented. In this way the formation of a leak flow and breakdowns can be prevented. The property reduces in practice the need to maintain and clean the device. In practice, a shielding gas, coming through a shielding-gas connection 304 can be used as the shielding-gas source, which is directed to a separate connection 320, which acts as a shielding-gas channel to the area 322. A shielding-gas source like that of FIG. 9 can also be envisaged as part of the embodiments shown in the other figures.

To clean and prevent dirtying of the joint between the body and the boiler wall it is also possible to use mechanical cleaning of the outer surface of the body of the ion source by sweeping, by a self-cleaning photo- and thermo-catalytic surfacing, and/or by raising the surface temperature to be sufficiently high, when impurities on the surface burn off or become electrically non-conducting.

With the aid of the embodiment of FIG. 3b, it is possible to direct the corona electrode 303 to the desired position relative to the flow direction of the flue gas PK, so that the dirtying of the electrode 303 can be reduced/prevented. The implementation permits the directing of the ion cloud to the desired collector surface, when the strength of the electric field E relative to a specific collector surface KP can be adjusted. By aligning the corona electrode, it is possible to seek to collect particles to the metal surface of the desired part of the boiler, for example, in such a way that the collected particles can be removed by means of sweeping devices in the boiler.

1. A boiler, comprising:
a flow channel for flue gases having a selected chamber delimited by walls made at least partly of conductive material, the selected chamber being grounded; and
a device arranged at least partially inside the selected chamber for forming a first electric field to collect fine particles of flue gases on the walls of the selected chamber, the device comprising:
an ion source for creating gas ions with aid of a corona discharge, the ion source comprising a corona electrode for creating the corona discharge, an electrically passive body having an opening for corona discharge, the corona electrode being located inside the electrically passive body and a fan/shielding-gas connection in the electrically passive body for feeding shielding gas inside the electrically passive body in contact with the corona electrode to prevent dirtying of the ion source, the shielding gas exiting the electrically passive body through the opening; and
a high-voltage source for the corona electrode;
wherein the walls of the selected chamber of the boiler form a ground potential for the corona electrode to collect the fine particles of flue gases on the walls of the selected chamber.

2. The boiler according to claim 1, wherein the electrically passive body has an outer surface having a surface patterning for increasing distance of a surface discharge between the body and the corona electrode.

3. The boiler according to claim 1, wherein the electrically passive body has side walls and a rear wall, the corona electrode extending through the rear wall.

4. The boiler according to claim 1, wherein the shielding gas connection is formed in the rear wall.

5. The boiler according to claim 1, wherein an operating voltage of the corona electrode is 50-95% of a breakdown voltage.

6. The boiler according to claim 1, wherein an operating voltage of the corona electrode is 80-90% of a breakdown voltage.

7. The boiler according to claim 1, wherein the electrically passive body is ceramic having resistivity of at least 4*106 ohm-cm at a temperature of 500° C.

8. The boiler according to claim 1, wherein the electrically passive body is ceramic having resistivity of at least 4*107 ohm-cm at a temperature of 500° C.

9. The boiler according to claim 1, wherein the electrically passive body is ceramic having resistivity of at least 4*108 ohm-cm at a temperature of 500° C.

10. The boiler according to claim 1, wherein the device is located in the selected chamber, wherein a flow velocity of the flue gases in an area of influence of the corona electrode is 0.1-1.5 m/s.

11. The boiler according to claim 1, wherein the device is located in the selected chamber, wherein a flow velocity of the flue gases in an area of influence of the corona electrode is 0.1-0.5 m/s.

12. The boiler according to claim 1, wherein the electrically passive body has a diameter that is 10-50% of a diameter of the selected chamber.

13. The boiler according to claim 1, wherein the electrically passive body has a diameter that is 15-40% of a diameter of the selected chamber.

14. The boiler according to claim 1, wherein the device is aligned so that the corona electrode is parallel with the selected chamber.

15. The boiler according to claim 1, wherein the corona electrode includes a corona needle.

16. The boiler according to claim 1, wherein the corona electrode is located at a distance from the walls acting as a collector surface, the distance being calculated by diving the operating voltage of the corona electrode by the voltage of the corona electrode that is 50-95% of a breakdown voltage of 7 kV/cm.

17. The boiler according to claim 1, wherein the operating voltage of the corona electrode is such that the corona electrode forms gas ions that form the first electric field which is at least for a specific length of the selected chamber stronger than a second electric field formed by the corona electrode against the ground potential.

18. The boiler according to claim 17, wherein the first electrical field is stronger than the second electric field against the ground potential of the flow channel over a length of 3-30 cm.

19. The boiler according to claim 17, wherein the first electrical field is stronger than the second electric field against the ground potential of the flow channel over a length of 10-25 cm.

20. The boiler according to claim 1, wherein the fan/shielding-gas connection comprises a fan for feeding a shielding gas in connection with a feed-through included in the wall of the selected chamber.

21. The boiler according to claim 1, wherein the ion source is located in the flow channel wherein a temperature of the flue gasses is less than 700° C.

22. The boiler according to claim 1, wherein the device is located in the flow channel wherein a temperature of the flue gasses is less than 500° C.

23. The boiler according to claim 1, wherein the electrically passive body comprises a gas guide for accelerating a flow of the shielding gas exiting the electrically passive body and an obstructing entry of flue gases inside the electrically passive body.

24. The boiler according to claim 1, wherein the gas guide includes a narrowing part and a diffusor part.

25. The boiler according to claim 24, wherein the narrowing part and the diffusor part are at an angle of 30-40° to a longitudinal direction of the electrically passive body.

26. The boiler according to claim 20, wherein the electrically passive body comprises a gas guide for accelerating the flow of the shielding gas exiting the electrically passive body and an obstructing entry of flue gases inside the electrically passive body, and the boiler further comprises a second fan for feeding a shielding gas inside the electrically passive body through the fan/shielding gas connection wherein the gas guide and the second fan are designed to create an excess pressure of 50-2000 Pa inside the electrically passive body relative to the selected chamber.

27. The boiler according to claim 20, wherein the electrically passive body comprises a gas guide for accelerating the flow of the shielding gas exiting the electrically passive body and obstructing entry of flue gases inside the electrically passive body and the boiler comprises a second fan for feeding a shielding gas inside the electrically passive body through the fan/shielding gas connection wherein the gas guide and the second fan are designed to create an excess pressure of 100-500 Pa inside the electrically passive body relative to the selected chamber.

28. The boiler according to claim 20, wherein the electrically passive body comprises a gas guide for accelerating the flow of the shielding gas exiting the electrically passive body and obstructing entry of flue gases inside the electrically passive body and the boiler comprises a second fan for feeding a shielding gas inside the electrically passive body through the fan/shielding gas connection wherein the gas guide and the second fan are designed to create an excess pressure of 50-2000 Pa inside the electrically passive body relative to the selected chamber and the ion source is arranged to create gas ions having a life of 30-150 ms with aid of the corona electrode.

29. The boiler according to claim 20, wherein the electrically passive body comprises a gas guide for accelerating the flow of the shielding gas exiting the electrically passive body and obstructing entry of flue gases inside the electrically passive body and the boiler comprises a second fan for feeding a shielding gas inside the electrically passive body through the fan/shielding gas connection wherein the gas guide and the second fan are designed to create an excess pressure of 50-2000 Pa inside the electrically passive body relative to the selected chamber and the ion source is arranged to create gas ions having a life of 50-80 ms with aid of the corona electrode.

30. The boiler according to claim 1, wherein the electrically passive body is fed through a feed-through of the walls of the chamber, the electrical passive body being arranged at least partially inside the selected chamber.
